(19) United States
(12) Patent Application Publication
(10) Pub. No.: US 2010/0025643 A1
(43) Pub. Date: Feb. 4, 2010

(54) Flame-retardant mixture for thermoplastic polymers, and flame-retardant polymers

(75) Inventors: Sebastian Hoerold, Diedorf (DE); Wolfgang Wanzke, Augsburg (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant International Ltd.

(21) Appl. No.: 12/221,236

(22) Filed: Jul. 31, 2008

(51) Int. Cl. C08K 5/5313

(52) U.S. Cl. 252/609; 524/133

(57) ABSTRACT

The invention relates to flame retardant mixtures for thermoplastic polymers, comprising a phosphinic salt of the formula (I) where M=Al (component A) and a fusible phosphinic salt of the formula (I) where M=Zn (component B),

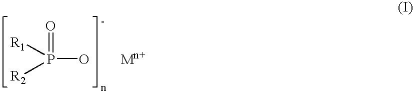

in which
R¹ and R² are identical or different and are C₁-C₆-alkyl, linear or branched, and/or aryl; and
n is from 1 to 3;
where the amount of component A present is from 5 to 95% by weight and the amount of component B present is from 5 to 95% by weight, and also flame-retardant polymers. The polymers are polyamides which contain, as aromatic dicarboxylic acids, terephthalic acid or isophthalic acid.

The present invention is described in the German priority application No. 10 2007 037 019.0, filed Jun. 8, 2007, which is hereby incorporated by reference as is fully disclosed herein.

The present invention relates to a flame-retardant mixture for thermoplastic polymers, and to flame-retardant polymers.

Preferred flame retardants used for semiaromatic, semicrystalline polyamides, these being thermoplastic polymers, are halogen compounds or red phosphorus, since these retain sufficient thermal stability at temperatures above 300° C. needed for the preparation and processing of these types of molding compositions. However, among the disadvantages of halogen-containing flame-retardant polyamides is that they are toxicologically hazardous, since they liberate halogen-containing substances during disposal by incineration. Polyamides which comprise red phosphorus have a dark intrinsic color, limiting the colors that can be produced. Substantial safety precautions are moreover needed during the production and processing of semiaromatic polyamides with red phosphorus as flame retardant, because of the high temperatures required and the formation of toxic phosphine.

Flame retardant mixtures are therefore proposed which do not have the abovementioned disadvantages.

Salts of phosphinic acids (phosphinates) have proven to be effective flame-retardant additives for thermoplastic polymers (DE-A 2 252 258 and DE-A-2 447 727). Calcium phosphinates and aluminum phosphinates have been described as particularly effective in polyesters and when compared with, for example, the alkali metal salts give less impairment of the properties of the polymer molding composition materials (EP-A-0 699 708). DE-A-196 07 635 describes calcium phosphinates and aluminum phosphinates as particularly effective flame retardants for polyamides. Polyamides are, polymers whose polymer chain has units that repeat by way of an amide group. Particularly suitable polyamides mentioned are nylon-6 and nylon-6,6. Molding compositions prepared from this material achieve UL 94 V-0 fire class at a specimen thickness of 1.2 mm.

Synergistic combinations of phosphinates with certain nitrogen-containing compounds have moreover been found, and are more effective flame retardants than the phosphinates alone in a large number of polymers (WO97/39053, and also DE-A-197 34 437 and DE-A-197 37 727).

Melamine and melamine compounds, inter alia, have been described as effective synergists, examples being melamine cyanurate and melamine phosphate, which themselves also have a certain flame-retardant action in certain thermoplastics, but are markedly more effective in combination with phosphinates.

High-molecular-weight derivatives of melamine, such as the condensates melam, melem, and melon, have been described as flame retardants, as also have appropriate reaction products of these compounds with phosphoric acid, e.g. dimelamine pyrophosphate and melamine polyphosphates. However, the amounts that have to be added in thermoplastics are relatively high, in particular in the case of glassfiber-reinforced materials.

DE-A-103 16 873 describes flame-retardant polyamide molding compositions composed of from 30 to 80% by weight of a semiaromatic, semicrystalline polyamide and from 1 to 30% by weight of a phosphinic or diphosphinic salt as flame retardant. Better effectiveness of the phosphinic salts is described in semiaromatic polyamides than in aliphatic polyamides.

Since miniaturization, particularly in the electronics industry, is producing very thin-walled components, UL 94 V-0 fire classification at 0.4 mm is being demanded for the molding compositions used for this purpose. Another important factor for thin-walled applications is good flowability of the polyamides.

A disadvantage with the additions described of flame retardants is the adverse effect on flowability in comparison with the non-flame-retardant polyamide, caused by the content of non-fusible solids.

It was therefore an object of the present invention to provide a flame-retardant mixture, and also good-flowability polymers which achieve UL 94 V-0 at 0.4 mm wall thickness when using a halogen-free flame-retardant system, and whose flowability achieves values similar to those for non-flame-retardant polymers.

Surprisingly, it has now been found that mixtures composed of aluminum phosphinates and of zinc phosphinates are more effective as flame retardants in certain polymers than aluminum phosphinates or zinc phosphinates alone, and moreover that the flowabilities that can be achieved are higher than when aluminum phosphinates are used alone. Surprisingly, it has moreover been found that the high heat resistance of the polymers, in particular of the polyamides, is substantially retained after addition of the phosphinates, and that the phosphinates/polymer mixtures can be processed at high temperatures without any polymer degradation or any discoloration phenomena.

Because these polymers have dimensional stability at high temperatures and have good fire performance, they, and in particular the polyamides, have very good suitability for the production of thin-walled moldings for the electrical and electronics industry.

The invention therefore provides a flame-retardant mixture for thermoplastic polymers comprising a phosphinic salt of the formula (I) where M=Al (component A) and a fusible phosphinic salt of the formula (I) where M=Zn (component B),

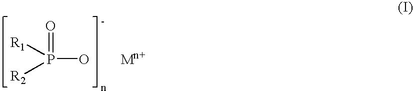

in which
R¹ and R² are identical or different and are C₁-C₆-alkyl, linear or branched, and/or aryl; and
n is from 1 to 3;
where the amount of component A present is from 5 to 95% by weight and the amount of component B present is from 5 to 95% by weight, and where the polymers are polyamides which contain, as aromatic dicarboxylic acids, terephthalic acid or isophthalic acid.

The amount of component A present is preferably from 50 to 95% by weight, and the amount of component B present is preferably from 5 to 50% by weight.

The invention likewise provides flame-retardant polymers which comprise, as flame retardant, a mixture composed of a phosphinic salt of the formula (I) where M=Al (component A) and a fusible phosphinic salt of the formula (I) where M=Zn (component B),

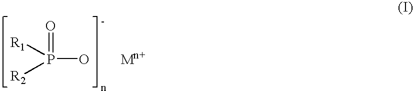

in which
R¹ and R² are identical or different and are C₁-C₆-alkyl, linear or branched, and/or aryl; and
n is from 1 to 3;
and where the polymers are polyamides which contain, as aromatic dicarboxylic acids, terephthalic acid or isophthalic acid.
It is preferable that R¹ and R² are identical or different and are methyl, ethyl, n-propyl, isopropyl, n-butyl, tert-butyl, n-pentyl and/or phenyl.

It is preferable that—if the polymers are polyamides—they are polyamides which contain, as aromatic dicarboxylic acids, terephthalic acid or isophthalic acid.

The inventive flame-retardant polymers can preferably comprise, as further component C, a nitrogen compound, phosphorus compound, or phosphorus-nitrogen compound.

It is preferable that component C is melamine phosphate, dimelamine phosphate, melamine pyrophosphate, melamine polyphosphates, melam polyphosphates, melem polyphosphates, and/or melon polyphosphates.

Component C is preferably melamine condensates, such as melam, melem, and/or melon.

The inventive flame-retardant polymer preferably comprises, as component C, oligomeric esters of tris(hydroxyethyl) isocyanurate with aromatic polycarboxylic acids, or is benzoguanamine, tris(hydroxyethyl) isocyanurate, allantoin, glycouril, melamine, melamine cyanurate, dicyandiamide, guanidine and/or carbodiimides.

Particular preference is given to melamine polyphosphate or melamine cyanurate.

The inventive flame-retardant polymer preferably comprises, as component D, a synthetic inorganic compound and/or a mineral product.

It is preferable that component D is an oxygen compound of silicon or is magnesium compounds, metal carbonates of metals of the second main group of the Periodic Table of the elements, red phosphorus, zinc compounds, or aluminum compounds.

It is preferable that the oxygen compounds of silicon are salts and esters of orthosilica and condensates thereof, or are silicates, zeolites, and silicas, or are glass powder, glass-ceramic powder or ceramic powder; the magnesium compounds are magnesium hydroxide, hydrotalcites, magnesium carbonates, or magnesium calcium carbonates; the zinc compounds are zinc oxide, zinc stannate, zinc hydroxystannate, zinc phosphate, zinc borate, or zinc sulfides; and the aluminum compounds are aluminum oxide, aluminum hydroxide, or aluminum phosphate or boehmite.

Particular preference is given to zinc borate or boehmite.

It is preferable that the inventive flame-retardant polymer comprises from 60 to 97% by weight of polymer, from 2 to 30% by weight of component A, and from 1 to 10% by weight of component B.

It is also preferable that the inventive flame-retardant polymer comprises 43 to 93% by weight of polymer, from 5 to 15% by weight of component A, from 2 to 10% by weight of component B, from 0 to 10% by weight of component C, and from 0 to 5% by weight of component D.

Preferred polymers of the inventive are polyamides.

The polyamides are preferably nylon-6, nylon-12, semiaromatic polyamides, and/or nylon-6,6. It is preferable that the materials here are semicrystalline polyamides.

Semiaromatic, semicrystalline polyamides suitable according to the invention can be either homopolyamides or copolyamides whose repeat units derive from dicarboxylic acids and from diamines, or else from aminocarboxylic acids or from the corresponding lactams. Suitable dicarboxylic acids are aromatic and aliphatic dicarboxylic acids, such as terephthalic acid, isophthalic acid, adipic acid, azeiaic acid, sebacic acid, dodecanedicarboxylic acid, and 1,4-cyclohexanedicarboxylic acid. Suitable diamines are aliphatic and cycloaliphatic diamines, such as hexamethylenediamine, nonamethylenediamine, decamethylenediamine, dodecamethylenediamine, 2-methylpentamethylenediamine, 1,4-cyclohexanediamine, di(4-diaminocyclohexyl)methane, di(3-methyl-4-aminocyclohexyl)methane. Suitable aminocarboxylic acids are aminocaproic acid and aminolauric acid, which can also be used in the form of the corresponding lactams: caprolactam and laurolactam.

The melting points of these semiaromatic polyamides are from 280 to 340° C., preferably from 295 to 325° C.

Among the polyamides, particular preference is given to those formed from terephtalic acid (TPA), isophtalic acid (IPA), and hexamethylenediamine, or from terephtalic acid, adipic acid, and hexamethylenediamine. Advantageous ratios here have been found to be about 70:30 TPA:IPA or, respectively, 55:45 TPA:adipic acid. The superior properties are in particular achieved via these two specific polyamides.

Copolyamides are products of the type which are produced from more than one polyamide-forming monomer. The properties of the polyamides can be varied very widely via the selection of the monomers and of the mixing ratio. Certain copolyamides using aromatic monomers are products of more interest than the aliphatic copolyamides for technical purposes. They feature a relatively high glass transition temperature and a relatively high melting point for the semicrystalline domains, giving them sufficient heat resistance for practical applications. Semicrystalline polyamides with high heat resistance can thus be produced starting from terephthalic acid and/or isophthalic acid and from polyamines such as hexamethylenediamine.

Semiaromatic copolyamides suitable according to the invention are described by way of example in Becker/Braun Kunststoff Handbuch [Plastics handbook] 3/4, Polyamide [Polyamides], edited by L. Bottenbruch and R. Binsack, chapter 6, Teilaromatische and aromatische Polyamide [Semiaromatic and aromatic polyamides], pp. 803-845, expressly incorporated herein by way of reference.

Semiaromatic copolyamides suitable according to the invention can also be block copolymers of the abovementioned polyamides with polyolefins, with olefin copolymers, with ionomers, or with chemically bonded or grafted elastomers; or with polyethers, e.g. with polyethylene glycol, polypropylene glycol, or polytetramethylene glycol. EPDM- or ABS-modified polyamides or copolyamides can also be used, as also can polyamides condensed during processing (“IM polyamide systems”).

The expression “phosphinic salt” hereinafter encompasses salts of phosphinic and of diphosphinic acids, and polymers of these.

The phosphinic salts prepared in an aqueous medium are in essence monomeric compounds. As a function of the reaction conditions, polymeric phosphinic salts can also sometimes be produced.

Examples of suitable phosphinic acids as constituent of the phosphinic salts are:
dimethylphosphinic acid, ethylmethylphosphinic acid, diethylphosphinic acid, methyl-n-propylphosphinic acid, methylphenylphosphinic acid, and diphenylphosphinic acid.

The present invention uses DEPAI (aluminum salt of diethylphosphinic acid) and DEPZn (zinc salt of diethylphosphinic acid) in a ratio of from 7:1 to 1:1, preferably in a ratio of from 5:1 to 2:1, and particularly preferably in a ratio of from 5:1 to 4:1.

The salts of the phosphinic acids according to the invention can be prepared by known methods as described in some detail by way of example in EP-A-0 699 708. The phosphinic acids here are by way of example reacted in aqueous solution with metal carbonates, with metal hydroxides, or with metal oxides.

The amount of the mixture of phosphinic salts to be added to the polymers can vary widely. The amount used is generally from 1 to 50% by weight, based on the plastics molding composition. The ideal amount depends on the nature of the polymer and on the nature of components C and D. Preference is given to from 3 to 40% by weight, in particular from 5 to 30% by weight, based on the plastics molding composition.

The abovementioned phosphinic salts can be used in various physical forms for the inventive flame retardant combination, as a function of the polymer used and of the desired properties. By way of example, the phosphinic salts can be milled to give a fine-particle form in order to achieve better dispersion in the polymer. The phosphinic salts as used according to the invention in the flame retardant combination are thermally stable, and neither decompose the polymers during processing nor affect the process of preparation of the plastics molding composition. The phosphinic salts are not volatile under the conventional conditions of preparation and processing of thermoplastic polymers.

The flame-retardant components A and B, and also, if appropriate, C and D, can be incorporated into the polyamides by, for example, premixing all of the constituents in the form of powder and/or of pellets in a mixer, and then homogenizing them in a compounding-polymer melt assembly (e.g. a twin-screw extruder). The melt is usually drawn off in the form of a strand, cooled, and pelletized. Components A and B, and also, if appropriate, C and D, can also be introduced separately by way of a metering system, directly into the compounding assembly.

It is likewise possible to admix the flame-retardant components A and B, and also, if appropriate, C and D, with finished polymer pellets or with finished polymer powder, and to process the mixture directly in an injection-molding machine to give moldings.

The inventive polyamides can comprise, as further components, from 5 to 60% by weight of fibrous or particulate fillers. Examples that may be mentioned of fibrous fillers are fibrous reinforcing agents, such as glass fibers, carbon fibers, aramid fibers, and potassium titanate whiskers, preference being given to glass fibers. The form in which the glass fibers are incorporated into the molding compositions can either be that of continuous-filament strands (rovings) or that of chopped material (short glass fibers). To improve compatibility with the semiaromatic polyamides, the glass fibers used can have been provided with a size and with a coupling agent. The diameter of the glass fibers usually used is in the range from 6 to 20 μm.

Suitable particulate fillers are, inter alia, glass beads, chalk, powdered quartz, talc, wollastonite, kaolin, and mica.

Examples of conventional additives are heat stabilizers, antioxidants, light stabilizers, lubricants, mold-release agents, nucleating agents, pigments, dyes, antidrip agents.

The inventive flame-retardant polyamides are suitable for the production of moldings, of. films, of filaments, and of fibers, for example via injection molding, extrusion, or pressing.

Fire protection of electrical and electronic equipment is set down in specifications and standards relating to product safety. In the USA, Underwriters Laboratories (UL) are responsible for technical fire-protection testing and approval procedures. The UL specifications are nowadays accepted worldwide. The fire tests for plastics were developed in order to determine the resistance of the materials to ignition and spread of flame.

As a function of fire-protection requirements, the materials have to pass horizontal burning tests (class UL 94 HB), or the more stringent vertical tests (UL 94 V-2, V-1, or V-0). These tests simulate low-energy ignition sources which occur in electrical devices, and to which plastics components in electrical modules can be exposed.

### EXAMPLES

1. Components Used

Commercially available polymers (pellets):

Nylon-6,6: Durethan® A 30 (Bayer AG, Germany)

Semiaromatic polyamides:

Nylon-6,T/6,6: Zytel® HTN FE 8200 (DuPont, USA): polyamide composed of terephthalic acid, diaminohexane, and 2-methyldiaminopentane

Glass fibers: Vetrotex EC 10 983, Vetrotex, France, for polyamides

Glass fibers: Vetrotex EC 10 952, Vetrotex, France for PBT

Flame-retardant components (pulverant):

Aluminum salt of diethylphosphinic acid, hereinafter termed DEPAI

Zinc salt of diethylphosphinic acid, hereinafter termed DEPZn,

Melting point 200° C.

Boehmite: Apyral® AOH 60, Nabaltec, Germany

Zinc borate: Firebrake® 500, Borax, USA

Melamine polyphosphate, hereinafter termed MPP, Melapur® 200, Ciba SC, Switzerland

Melamine cyanurate, hereinafter termed MC, Melapur® MC 50, Ciba SC, Switzerland

2. Preparation, Processing, and Testing of Flame-Retardant Plastics Molding Compositions

The polymers were processed in a twin-screw extruder (Leistritz ZSE 25/44) at temperatures of from 260 to 280° C. (PA 6.6,GR) and from 300 to 320° C. (semiaromatic polyamides). The homogenized polymer strand was drawn off, cooled in a water bath, and then pelletized.

The flame retardant components were mixed in the ratio stated in the tables and added to the polymer melt by way of a side feed. The glass fibers were likewise added by way of a side feed.

After adequate drying, the molding compositions were processed in an injection-molding machine (Arburg 320 C Allrounder) to give test specimens, and tested and classified for flame retardancy on the basis of the UL 94 test (Underwriters Laboratories) and the glow-wire test to IEC 60695-2. The flowability of the molding composition was determined via injection of flow spirals. The length of the flow path is a measure of flowability under injection-molding conditions.

All of the tests of each series were, unless otherwise stated, carried out under identical conditions (temperature profiles, screw geometries, injection-molding parameters, etc.) for reasons of comparability. Unless otherwise stated, quantities stated are always in percent by weight.

Table 1 shows that 15% addition of DEPAI in semiaromatic polyamide achieves V-0, but DEPZn at the same concentration does not. The flowability of the compounded materials is higher with DEPZn than with DEPAI. Surprisingly, it has now been found that DEPAI can be partially replaced by DEPZn with retention of the fire classification, but with improvement in flowability. Addition of calcium stearate to improve flowability, as in the prior art, in contrast brings about only a comparatively small improvement in flow path length.

TABLE 1
DEPAl and DEPZn as flame retardants
in glassfiber-reinforced PA 6T/66
(comp. = comparison)

| | Examples | | | | |
|---|---|---|---|---|---|
| | 1 (comp.) | 2 (comp.) | 3 (inv.) | 4 (inv.) | 5 (comp.) |
| Nylon-6,T/6,6 | 55 | 55 | 55 | 55 | 54.65 |
| Glass fibers | 30 | 30 | 30 | 30 | 30 |
| DEPAl | 15 | | 13 | 10 | 15 |
| DEPZn | | 15 | 2 | 5 | |
| Calcium | | | | | 0.35 |
| stearate | | | | | |
| UL 94 0.8 mm | V-0 | n.c. | V-0 | V-0 | V-0 |
| Flow path | 37 | 48 | 44 | 48 | 39 |
| length in cm | | | | | |

*⁾n.c. = not classifiable

Table 2 shows that the combination of DEPAI and DEPZn provides good mechanical properties comparable with those of the non-flame-retardant compounded polyamide materials. Neither any discoloration phenomena nor any polymer degradation are observed, despite the processing temperature of the nylon-6,T/6,6, which is 300° C.

TABLE 2
DEPAl and DEPZn as flame retardants in glassfiber-reinforced
PA 6T/66 Mechanical properties (inv. = invention)

| | Examples | | | |
|---|---|---|---|---|
| | 6 (comp.) | 7 (comp.) | 8 (inv.) | 9 (inv.) |
| PA 6,T/6,6 | 70 | 55 | 55 | 55 |
| Glass fibers | 30 | 30 | 30 | 30 |
| DEPAl | | 15 | 13 | 10 |
| DEPZn | | | 2.0 | 5.0 |
| UL 94 0.8 mm | n.c. | V-0 | V-0 | V-0 |
| Flow path length in cm | 47 | 44.1 | 50.7 | 56.3 |
| E-modulus of elasticity | 10030 | 10730 | 10560 | 10540 |
| [MPa]* | | | | |
| Ultimate tensile strength | 199 | 163 | 162 | 166 |
| [N/mm²] | | | | |
| Tensile strain at break [%]* | 3.2 | 3 | 2.8 | 2.8 |
| Impact resistance (Charpy) | 74.8 | 68.4 | 63.2 | 64.8 |
| Notched impact resistance | 10.6 | 9.6 | 8.5 | 8.5 |

Table 3 shows that boehmite and zinc borate have synergistic effect with respect to DEPAI, and here again the combination of DEPAI and DEPZn achieves improved flowability together with V-0 classification.

TABLE 3
DEPAl and DEPZn with zinc borate and boehmite as
synergistic in glassfiber-reinforced PA 6T/66

| | Examples | | | | |
|---|---|---|---|---|---|
| | 10 | 11 | 12 | | |
| | (comp.) | (comp.) | (inv.) | 13 (inv.) | 14 (inv.) |
| Nylon-6,T/6,6 | 55 | 55 | 55 | 55 | 55 |
| Glass fibers | 30 | 30 | 30 | 30 | 30 |
| DEPAl | 13 | 13 | 11 | 11 | 10 |
| DEPZn | | | 2 | 2 | 3 |
| Zinc borate | 2 | | 2 | | |
| Boehmite | | 2 | | 2 | 2 |
| UL 94 0.8 mm | V-0 | V-0 | V-0 | V-0 | V-0 |
| Flow path length in | 37 | 38 | 44 | 45 | 47 |
| cm | | | | | |

*⁾n.c. = not classifiable

In aliphatic polyamides, a combination of DEPAI with MPP and zinc borate can achieve V-0 (example 10). DEPZn does not achieve any fire classification in a comparable formulation (example 11). Surprisingly, here again the combination of DEPAI and DEPZn leads to good-flowability flame-retardant polyamides.

TABLE 4
DEPAl and DEPZn with melamine polyphosphate
in glassfiber-reinforced PA 66

| | Examples | | | | |
|---|---|---|---|---|---|
| | 10 | 11 | 12 | | |
| | (comp.) | (comp.) | (inv.) | 13 (inv.) | 14 (inv.) |
| Nylon-6,6 | 51 | 51 | 51 | 51 | 51 |
| Glass fibers | 30 | 30 | 30 | 30 | 30 |
| DEPAl | 12 | | 10 | 8 | 6 |
| DEPZn | | 12 | 2 | 4 | 6 |
| Zinc borate | 1 | 1 | 1 | 1 | 1 |
| MPP | 6 | 6 | 6 | 6 | 6 |
| UL 94 0.8 mm | V-0 | n.c. | V-0 | V-0 | V-0 |
| Flow path length in | 37 | 49 | 44 | 47 | 50 |
| cm | | | | | |

The dimensional stability of these polyamides at high temperatures and their advantageous fire performance make them particularly suitable for the production of thin-walled moldings for the electrical and electronics industry.

1. A flame retardant mixture for thermoplastic polymers, comprising a phosphinic salt of the formula (I) where M=Al (component A) and a fusible phosphinic salt of the formula (I) where M=Zn (component B), 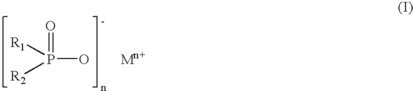
wherein
R¹ and R² are identical or different and are C₁-C₆-alkyl, linear or branched, or aryl; and
n is from 1 to 3;
where the amount of component A present is from 5 to 95% by weight and the amount of component B present is from 5 to 95% by weight, and the wherein the thermoplastic polymers are polyamides containing, as aromatic dicarboxylic acids, terephthalic acid or isophthalic acid.

2. The flame retardant mixture as claimed in claim 1, wherein the amount of component A present is from 50 to 95% by weight and the amount of component B present is from 5 to 50% by weight.

3. A flame-retardant polymer comprising, as a flame retardant, a mixture composed of a phosphinic salt of the formula (I) where M=Al (component A) and a fusible phosphinic salt of the formula (I) where M=Zn (component B), 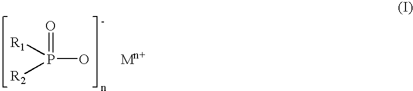
wherein
R¹ and R² are identical or different and are C₁-C₆-alkyl, linear or branched, or aryl; and
n is from 1 to 3;
and a polymer, wherein the polymer is a polyamide containing, as aromatic dicarboxylic acids, terephthalic acid or isophthalic acid.

4. The flame-retardant polymer as claimed in claim 3, wherein R¹ and R² are identical or different and are methyl, ethyl, n-propyl, isopropyl, n-butyl, tert-butyl, n-pentyl or phenyl.

5. The flame-retardant polymer as claimed in claim 3, further comprising at least one component C, wherein the at least one component C is a nitrogen compound, phosphorus compound, or phosphorus-nitrogen compound.

6. The flame-retardant polymer as claimed in claim 5, wherein the at least one component C is melamine phosphate, dimelamine phosphate, melamine pyrophosphate, melamine polyphosphates, melam polyphosphates, melem polyphosphates, melon polyphosphates or a mixture thereof.

7. The flame-retardant polymer as claimed in claim 5, wherein the at least one component C is a melamine condensate.

8. The flame-retardant polymer as claimed in claim 5, wherein the at least one component C is oligomeric ester of tris(hydroxyethyl) isocyanurate with aromatic polycarboxylic acids, or is benzoguanamine, tris(hydroxyethyl) isocyanurate, allantoin, glycouril, melamine, melamine cyanurate, dicyandiamide, guanidine carbodiimides, or a mixture thereof.

9. The flame-retardant polymer as claimed in claim 3, further comprising at least one component D, wherein the at least one component D is a synthetic inorganic compound, a mineral product or a mixture thereof.

10. The flame-retardant polymer as claimed in claim 9, wherein the at least one component D is an oxygen compound of silicon, a magnesium compound, a metal carbonate of metals of the second main group of the Periodic Table of the elements, red phosphorus, zinc compounds, or aluminum compounds.

11. The flame-retardant polymer as claimed in claim 10, wherein the oxygen compounds of silicon are salts and esters of orthosilica and condensates thereof, silicates, zeolites, silicas, glass powder, glass-ceramic powder or ceramic powder; the magnesium compounds are magnesium hydroxide, hydrotalcites, magnesium carbonates, or magnesium calcium carbonates; the zinc compounds are zinc oxide, zinc stannate, zinc hydroxystannate, zinc stearate, zinc phosphate, zinc borate, or zinc sulfides; and the aluminum compounds are aluminum hydroxide, boehmite, or aluminum phosphate.

12. The flame-retardant polymer as claimed in claim 3, comprising from 60 to 97% by weight of the polymer, from 2 to 30% by weight of component A, and from 1 to 10% by weight of component B.

13. The flame-retardant polymer as claimed in claim 3, comprising from 40 to 93% by weight of polymer, from 5 to 15% by weight of component A, from 2 to 10% by weight of component B, from 0 to 10% by weight of the at least one component C, and from 0 to 5% by weight of at least one component D, wherein the at least one component D is a nitrogen compound, phosphorus compound. phosphorus-nitrogen compound, or a mixture thereof.

14. The flame-retardant polymer as claimed in claim 7, wherein the melamine condensate is melam, melem or melon.
